(19) United States
(12) Patent Application Publication
(10) Pub. No.: US 2010/0326082 A1
(43) Pub. Date: Dec. 30, 2010

(54) METHODS AND APPARATUS FOR COMBUSTOR FUEL CIRCUIT FOR ULTRA LOW CALORIFIC FUELS

(76) Inventors: Willy Steve Ziminsky, Simpsonvillle, SC (US); Lewis Berkley Davis, JR., Niskayuna, NY (US)

Correspondence Address: JOHN S. BEULICK (17851);ARMSTRONG TEASDALE LLP, 7700 Forsyth Boulevard, Suite 1800, St. Louis, MO, 63105, US

(21) Appl. No.: 12/494,961

(22) Filed: Jun. 30, 2009

(51) Int. Cl. F02C 1/00; F02C 7/22

(52) U.S. Cl. 60/772; 60/746

(57) ABSTRACT

A method for controlling a gas turbine combustion system includes supplying an ultra low calorific fuel to a combustor of the combustion system through a first fuel circuit, controlling a supply of the ultra low calorific fuel through a second fuel circuit as required to control the volumetric flow of the ultra low calorific fuel through the combustor, and combusting the ultra low calorific fuel in the combustor.

### BACKGROUND OF THE INVENTION

The field of the present invention relates generally to the use of ultra low calorific fuels and more particularly to methods and apparatus for using such fuels for energy production.

Ultra low calorific fuels, i.e., fuels having a heating value of about 40 MJ/kg or less, which may include furnace gases, biomass gasification, or fuels with CH₄ content less than 10%, H₂ content less than 10% and N₂ content greater than 40% are typically “opportunity” fuels that are available as a waste stream or as the byproduct of a processing or manufacturing plant. Examples of these fuels are the so-called “blast furnace” gases (BFG) and “coke oven” gases (COG) that are generated from the smelting of iron. Even though such fuels are essentially “free,” there is a cost of compression for their use in a gas turbine. The combustion of ultra low calorific fuels in gas turbines generally present a significant design challenge given the large volumetric fuel flow required for a given energy input and the low reactivity of the fuel. To accommodate these fuels, at least some known combustion systems include fuel injectors that are large enough to pass the required site specific fuel volume such that air and fuel velocities are low enough for flame stabilization. Moreover, some known combustion systems rely on fuel blending with a more reactive fuel that enables the combustion of the gas in an existing low to medium calorific fuels combustor.

It would therefore be desirable to provide a combustor or combustion system that can utilize both ultra low calorific fuels and higher energy fuels, as desired, without having to rely on injectors that are designed to pass the entire fuel volume needed for each type of fuel, and to provide a combustion system that does not rely on fuel blending to burn ultra low calorific fuels.

### BRIEF DESCRIPTION OF THE INVENTION

In one aspect, some embodiments of the present disclosure provide a method for controlling a gas turbine combustion system. The method includes supplying an ultra low calorific fuel to a combustor of the combustion system through a first fuel circuit, controlling a supply of the ultra low calorific fuel through a second fuel circuit as required to control the volumetric flow of the ultra low calorific fuel through the combustor, and combusting the ultra low calorific fuel in the combustor.

In another aspect, some embodiments of the present disclosure provide a diffusion combustion system. The diffusion combustion system includes a combustor having one or more fuel inlets, an endcover, a combustion casing, and a combustion liner. The combustor is configured to accept an ultra low calorific fuel through a first fuel circuit, control a supply of the ultra low calorific fuel through a second fuel circuit as required to control the volumetric flow of the ultra low calorific fuel through the combustor, and combust the ultra low calorific fuel in the combustor.

### BRIEF DESCRIPTION OF THE DRAWINGS

FIG. 1 is a cross sectional view of an exemplary combustor.

FIG. 2 is a schematic block diagram of an exemplary control circuit that may be used for controlling the combustor of FIG. 1.

### DETAILED DESCRIPTION OF THE INVENTION

Embodiments of the present disclosure leverage a quaternary fuel system architecture to facilitate increasing physical fuel flow area available to a designer. For example, this architecture enables the use of a low to medium calorific fuels combustor for a wide range of ultra low calorific fuels, without site specific resizing of the main fuel nozzles by leveraging a combustor casing fuel circuit. The quaternary fuel system architecture allows use of these fuels without fuel blending and without requiring validation of site-specific resized main combustion nozzles. The additional fuel flow area and flexibility provided by the quaternary system enables fuel introduction at the correct pressure ratio despite varying calorific values. Thus, not only is the additional cost of fuel compression reduced, but the injection velocities from the main fuel nozzles are also facilitated to be reduced. The reduction of velocities through the main fuel nozzles facilitates impacting the stability of the diffusion flames that characterize these systems. Additionally, by premixing a portion of the fuel with the air upstream of the main fuel nozzles, flame lengths are also facilitated to be reduced, thus effectively creating a longer residence time for the combustion process.

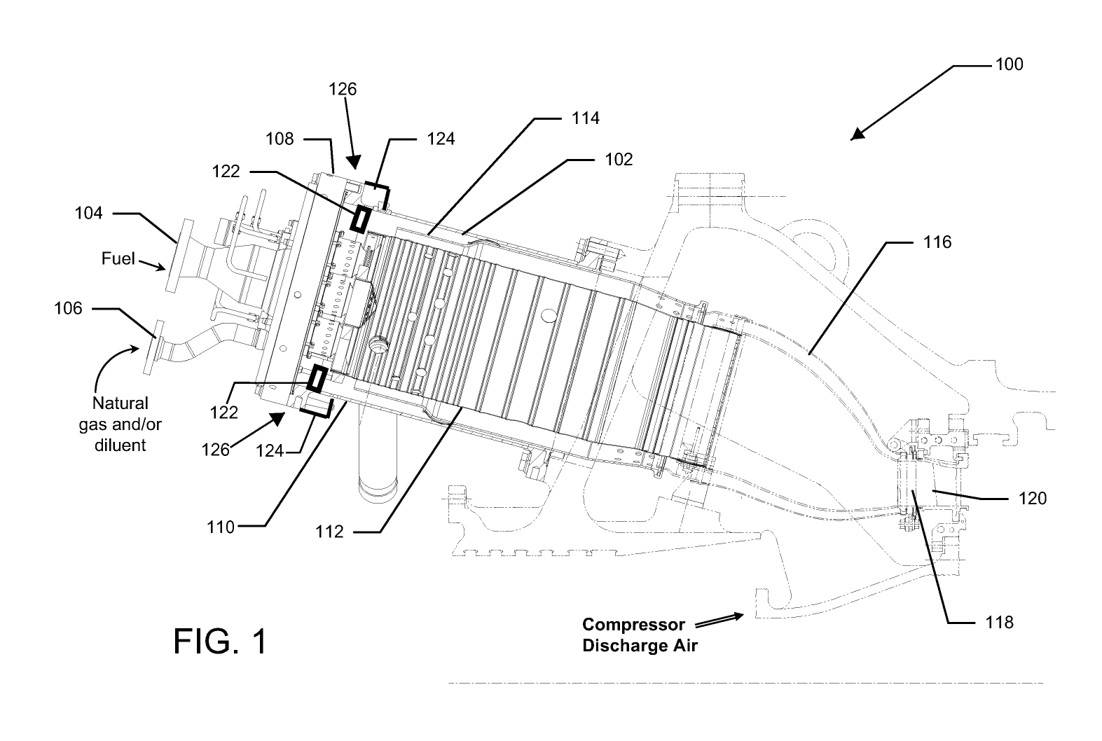

More specifically, and referring to FIG. 1, in the exemplary embodiment, an integrated gasification combined cycle (IGCC) combustion system includes a multi-nozzle quiet combustor (MNQC) 102 having one or more fuel inlets 104, a natural gas and/or diluent inlet 106, an endcover 108, a combustion casing 110, and a combustion liner 112. MNQC 102 further includes a flow sleeve 114, a transition piece 116, and a stage one nozzle.

In various embodiments, a plurality of quaternary pegs (“quat pegs”) 122 coupled in fluid communication with a quaternary manifold (“quat manifold”) 124 are provided near endcover 108. The term “quaternary” has been used in conjunction with GE Power Systems' DLN-2 burner to represent a premixed manifold and pegs through which a fuel or fuel mixture can be injected to facilitate dynamics abatement. In the present disclosure, the term “quaternary” is used to denote an architecture that can facilitate increasing the physical fuel flow area available to a designer, thereby enabling a low to medium calorific fuels combustor to operate with a wide range of ultra low calorific fuels without site specific resizing of the main fuel nozzles. More specifically, an additional fuel circuit including quat pegs 122 and quat manifold 124 upstream of fuel nozzle 118 is provided to introduce the fuel to combustor 102. In some embodiments, fifteen or sixteen quat pegs 122 are spaced circumferentially around combustion casing 110. Alternately, more or less than fifteen pegs 122 can be included in other embodiments. In the exemplary embodiment, quat pegs 122 are part of the injection system of quat manifold 124, although in other embodiments, injectors other than pegs 122 can be used, provided the injectors are configured to introduce the fuels into the flow path of the combustion system.

The injection of fuel through quat pegs 122 or other injectors depends upon a pressure ratio schedule, such that when the effective area in the normal fuel circuit is insufficient for the fuel being used, a control system (not shown in FIG. 1) would direct additional fuel flow through the additional fuel circuit. A very large volumetric fuel flow for a given energy input to the turbine is required for ultra low calorific fuels, which is why the additional fuel circuit is needed to accommodate an additional fuel nozzle area. Thus, various embodiments of the present disclosure use a fuel circuit available on other types of combustion systems for dynamics control and make it available as an additional fuel circuit in a diffusion combustion system to provide an additional fuel flow area.

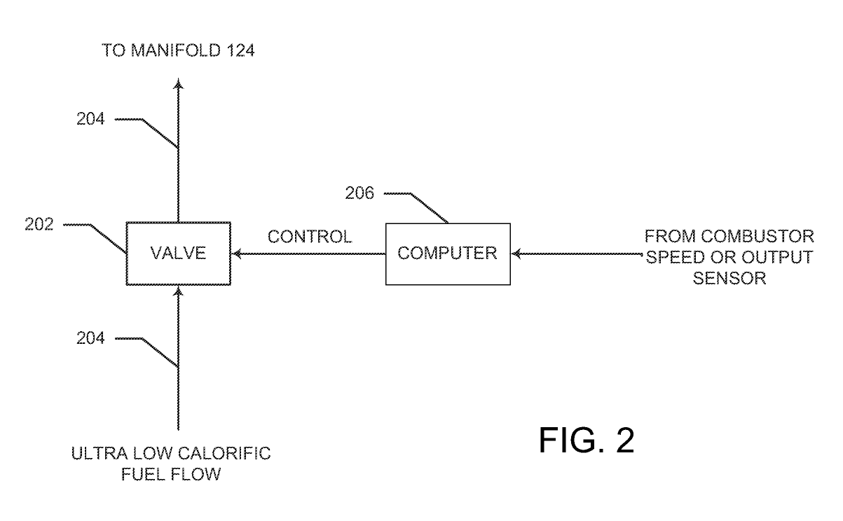

Referring now to FIG. 2, some embodiments of the present disclosure include a valve 202 that controls fuel flow 204. Valve 202 is controlled by a suitable electronic device 206, which may be a computer, processor, or controller, for example. (For convenience, “electronic device 206” will hereinafter be referred to, without loss of generality, as “computer 206.”) More specifically, MNQC fuel flow 204 is controlled to a target gas turbine output, such that computer 206 functions as a feedback controller, i.e., fuel flow 204 is adjusted to control the output of the gas turbine, subject to pressure limitations.

To summarize, some embodiments of the present disclosure provide a method for controlling an IGCC combustion system 100. The method includes supplying an ultra low calorific fuel to a combustor 102 of the combustion system 100 through a first fuel circuit 104, controlling a supply of the ultra low calorific fuel through a second fuel circuit 122, 124 as required to control the volumetric flow of the ultra low calorific fuel through the combustor 102, and combusting the ultra low calorific fuel in the combustor 102.

In some embodiments, controlling a supply of the ultra low calorific fuel through the second fuel circuit 122, 124 includes injecting fuel through fuel injectors 122 to introduce a flow of fuel into a flow path of the combustor 102. Also in some embodiments, controlling a supply of the ultra low calorific fuel through second fuel circuit 122, 124 includes controlling a flow of fuel into a manifold 124 coupled in fluid communication with injectors 122. Controlling a flow of fuel into manifold 124 can also include controlling a flow of fuel into a manifold 124 coupled in fluid communication with a plurality of quat pegs 122. Controlling a flow of fuel into a manifold 124 in fluid communication with a plurality of quat pegs 122 can also include controlling a flow of the fuel into a manifold 124 coupled in fluid communication with a plurality of quat pegs 122 spaced circumferentially about a combustion casing 110 of combustor 102. Manifold 124 and quat pegs 122 can also be located proximate to end cover 108 in some embodiments. Also, in some embodiments, controlling a supply of the ultra low calorific fuel through a second fuel circuit 122, 124 as required to control the volumetric flow of the ultra low calorific fuel through combustor 102, further includes utilizing a computer 206 to adjust a fuel flow through second fuel circuit 122, 124 to control an output or speed of the gas turbine, subject to pressure limitations.

In another aspect, some embodiments of the present disclosure provide a diffusion combustion system 100. The diffusion combustion system includes a combustor 102 that includes one or more fuel inlets 104, an endcover 108, a combustion casing 110, and a combustion liner 112. Combustor 102 is operable with an ultra low calorific fuel through a first fuel circuit 104, and to control a supply of the ultra low calorific fuel through a second fuel circuit 122, 124 as required to control the volumetric flow of the ultra low calorific fuel through combustor 102, and to combust the ultra low calorific fuel in combustor 102.

In some of the system embodiments, to control a supply of the ultra low calorific fuel through second fuel circuit 122, 124, combustor 102 injects fuel through fuel injectors 122 to introduce a flow of fuel into a flow path of combustor 102. Also, to control the supply of the ultra low calorific fuel through second fuel circuit 122, 124, combustor 102 controls a flow of fuel into a manifold 124 coupled in fluid communication with injectors 122. In yet other embodiments, to control the flow of fuel into a manifold 124 coupled in fluid communication with injectors 122, combustor 102 controls the flow of fuel into a manifold 124 coupled in fluid communication with a plurality of quat pegs 122. In some embodiments, the plurality of quat pegs 122 are spaced circumferentially around combustion casing 110 of combustor 102. Also, some embodiments also include a computer 206 that adjusts a fuel flow through second fuel circuit 122, 124 to control an output or speed of the gas turbine, subject to pressure limitations.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for controlling a gas turbine combustion system, said method comprising:
supplying an ultra low calorific fuel to a combustor of the combustion system through a first fuel circuit;
controlling a supply of the ultra low calorific fuel through a second fuel circuit as required to control the volumetric flow of the ultra low calorific fuel through the combustor; and
combusting the ultra low calorific fuel in the combustor.

2. A method in accordance with claim 1 wherein said controlling a supply of the ultra low calorific fuel through the second fuel circuit comprises injecting fuel through fuel injectors to introduce a flow of fuel into a flow path of the combustion system.

3. A method in accordance with claim 2 wherein said controlling a supply of the ultra low calorific fuel through the second fuel circuit comprises controlling a flow of fuel into a manifold coupled in fluid communication with the injectors.

4. A method in accordance with claim 3 wherein said controlling a flow of fuel into a manifold coupled in fluid communication with the injectors comprises controlling a flow of fuel into a manifold coupled in fluid communication with a plurality of quat pegs.

5. A method in accordance with claim 4 wherein said controlling a flow of fuel into a manifold coupled in fluid communication with a plurality of quat pegs further comprises controlling a flow of fuel into a manifold coupled in fluid communication with a plurality of quat pegs spaced circumferentially about a combustion casing of the combustor.

6. A method in accordance with claim 1 wherein said controlling a supply of the ultra low calorific fuel through a second fuel circuit as required to control the volumetric flow of the ultra low calorific fuel through the combustor further comprises utilizing a computer to adjust a fuel flow through the second fuel circuit to control an output or speed of the gas turbine, subject to pressure limitations.

7. A method in accordance with claim 6 wherein said controlling a supply of the ultra low calorific fuel through the second fuel circuit comprises injecting the fuel through fuel injectors configured to introduce a flow of fuel into a flow path of the combustion system.

8. A method in accordance with claim 7 wherein said controlling a supply of the ultra low calorific fuel through the second fuel circuit comprises controlling a flow of the fuel into a manifold coupled in fluid communication with the injectors.

9. A method in accordance with claim 8 wherein said controlling a flow of the fuel into a manifold coupled in fluid communication with the injectors comprises controlling a flow of the fuel into a manifold coupled in fluid communication with a plurality of quat pegs.

10. A method in accordance with claim 9 wherein said controlling a flow of the fuel into a manifold coupled in fluid communication with a plurality of quat pegs further comprises controlling a flow of fuel into a manifold coupled in fluid communication with a plurality of quat pegs spaced circumferentially about a combustion casing of the combustor.

11. A diffusion combustion system comprising a combustor comprising at least one fuel inlet, an endcover, a combustion casing, and a combustion liner, said combustor configured to:
accept an ultra low calorific fuel supplied through a first fuel circuit;
control a supply of the ultra low calorific fuel through a second fuel circuit as required to control the volumetric flow of the ultra low calorific fuel through the combustor; and
combust the ultra low calorific fuel in said combustor.

12. A system in accordance with claim 11 wherein to control a supply of the ultra low calorific fuel through a second fuel circuit, said combustor is configured to inject the fuel through fuel injectors to introduce a flow of fuel into a flow path in said combustion system.

13. A system in accordance with claim 12 wherein to control the supply of the ultra low calorific fuel through a second fuel circuit, said combustor is configured to control a flow of fuel into a manifold coupled in fluid communication with said fuel injectors.

14. A system in accordance with claim 13 wherein to control the flow of fuel into a manifold coupled in fluid communication with said fuel injectors, said combustor is configured to control the flow of fuel into a manifold coupled in fluid communication with a plurality of quat pegs.

15. A system in accordance with claim 14 wherein said plurality of quat pegs are spaced circumferentially about said combustion casing.

16. A system in accordance with claim 11 further comprising a computer configured to adjust a fuel flow through said second fuel circuit to control an output or speed of a gas turbine, subject to pressure limitations.

17. A system in accordance with claim 16 wherein to control a supply of the ultra low calorific fuel through a second fuel circuit, said combustor is configured to inject fuel through a plurality of fuel injectors configured to introduce a flow of fuel into a flow path of said combustion system.

18. A system in accordance with claim 17 wherein to control the supply of the ultra low calorific fuel through a second fuel circuit, said combustor is configured to control the flow of fuel into a manifold coupled in fluid communication with said fuel injectors.

19. A system in accordance with claim 18 wherein said fuel injectors comprise a plurality of quat pegs.

20. A system in accordance with claim 19 wherein said quat pegs are spaced circumferentially about a combustion casing of the combustor.
